(19) United States
(12) Patent Application Publication
(10) Pub. No.: US 2026/0204776 A1
(43) Pub. Date: Jul. 16, 2026

(54) CIRCUIT BOARD ASSEMBLY AND DISPLAY DEVICE INCLUDING THE SAME

(71) Applicant: SAMSUNG ELECTRONICS CO., LTD., Suwon-si (KR)

(72) Inventors: Dukhyun LEE, Suwon-si (KR); Yuju BAK, Suwon-si (KR); Sanggi OH, Suwon-si (KR); Gihoon LEE, Suwon-si (KR); Jungseok LEE, Suwon-si (KR)

(21) Appl. No.: 19/531,328

(22) Filed: Feb. 5, 2026

Related U.S. Application Data
(63) Continuation of application No. PCT/KR2026/000460, filed on Jan. 8, 2026.

(30) Foreign Application Priority Data
Jan. 10, 2025 (KR) 10-2025-0003902
Feb. 4, 2025 (KR) 10-2025-0013494

(51) Int. Cl. H01Q 1/52; H01Q 1/22; H01Q 5/30; H01Q 21/28

(52) U.S. Cl. CPC H01Q 1/521; H01Q 1/22; H01Q 5/30; H01Q 21/28

(57) ABSTRACT

A display device may include a display panel, and a communication assembly. The communication assembly may include a T-shaped communication substrate including a main region and a first region and a second region respectively disposed on two opposite sides of the main region, a first antenna disposed on a surface of the first region, and a second antenna disposed on a same plane as the first region and disposed on a surface of the second region.

### CROSS-REFERENCE TO RELATED APPLICATIONS

This application is a continuation of International Application No. PCT/KR2026/000460 designating the United States, filed on January 8, 2026, in the Korean Intellectual Property Receiving Office and claiming priority to Korean Patent Application Nos. 10-2025-0003902, filed on January 10, 2025, and 10-2025-0013494, filed on February 4, 2025, in the Korean Intellectual Property Office, the disclosures of each of which are incorporated by reference herein in their entireties.

### BACKGROUND

### Field

The disclosure relates to a circuit board assembly and a display device including the same.

### Description of Related Art

A display device is a type of output device that visually displays data information such as text or figures and images, and may include a television, various monitors, and various portable terminals (e.g., a notebook, a tablet PC, and a smartphone).

A display device may support wireless communication functions such as wi-fi or Bluetooth. For example, a display device may be equipped with an antenna having a very wide frequency band covering a plurality of service bands, or a multi-band antenna operating in dual or multiple frequency bands. For example, a display device may be equipped with a plurality of antennas corresponding to each frequency band.

As a printed circuit board (PCB) included in a display device becomes lighter and smaller, antenna performance may deteriorate due to signal interference or collision between a plurality of antennas disposed on the printed circuit board.

Therefore, when a plurality of antennas are disposed on a printed circuit board having a limited area, a method for securing isolation between the plurality of antennas may be required.

The above-described information may be provided as related art for the purpose of helping understanding of the disclosure. No assertion or determination is made as to whether any of the foregoing is applicable as background art in relation to the disclosure.

### SUMMARY

Embodiments of the disclosure provide a display device including a technology for minimizing and/or reducing signal interference occurring between a plurality of antennas disposed on a printed circuit board assembly.

A display device according to an example embodiment of the disclosure may include: a display panel, and a communication assembly. The communication assembly may include a T-shaped communication substrate including a main region and a first region and a second region respectively disposed on two opposite sides of the main region, a first antenna disposed on a surface of the first region, and a second antenna disposed on a same plane as the first region and disposed on a surface of the second region.

A printed circuit board assembly according to an example embodiment of the disclosure may include: a T-shaped communication substrate including a main region and a first region and a second region respectively disposed on two opposite sides of the main region, a first antenna disposed on a surface of the first region, and a second antenna disposed on a same plane as the first region and disposed on a surface of the second region. Wherein a size of the first region and a size of the second region may be smaller than a size of the main region, and an upper end of the main region, an upper end of the first region, and an upper end of the second region may be aligned.

A display device according to an example embodiment of the disclosure may provide a communication assembly with enhanced antenna performance while being implemented in reduced weight and size.

A display device according to an example embodiment of the disclosure may provide a communication assembly that secures isolation between antennas and reduces interference between radiation signals.

The disclosure is not limited to the foregoing but various modifications or changes may rather be made thereto without departing from the spirit and scope of the disclosure.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a front exploded perspective view illustrating an example display device according to various embodiments;

FIG. 2 is a rear exploded perspective view illustrating an example display device according to various embodiments;

FIG. 3 is a diagram illustrating a rear view of a chassis included in a display device according to various embodiments;

FIG. 4 is a diagram illustrating a rear view of a first communication assembly viewed from the rear with respect to a display device according to various embodiments;

FIG. 5 is a diagram illustrating directions of current applied to first to third antennas included in a first communication assembly according to various embodiments;

FIGS. 6A, 6B and 6C are diagrams illustrating radiation patterns of electrical signals radiated from first to third antennas included in a first communication assembly according to various embodiments; and

FIG. 7 is a table showing mutual isolation between first to third antennas included in a first communication assembly according to various embodiments.

### DETAILED DESCRIPTION

Various example embodiments of the disclosure and terms used therein are not intended to limit the technical features described in the disclosure to specific embodiments, and should be understood to include various modifications, equivalents, or substitutes. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as "A or B," "at least one of A and B," “at least one of A or B,” "A, B, or C," "at least one of A, B, and C," and “at least one of A, B, or C,” may include all possible combinations of the items enumerated together in a corresponding one of the phrases. As used herein, such terms as "1st" and "2nd," or “first” and "second" may be used to simply distinguish a corresponding component from another, and does not limit the components in other aspect (e.g., importance or order).

In the disclosure, the terms "front and rear direction", "left and right direction", and "upper and lower direction" to be used below may be used with respect to the illustrated drawings, and the shape and position of each component are not limited thereto.

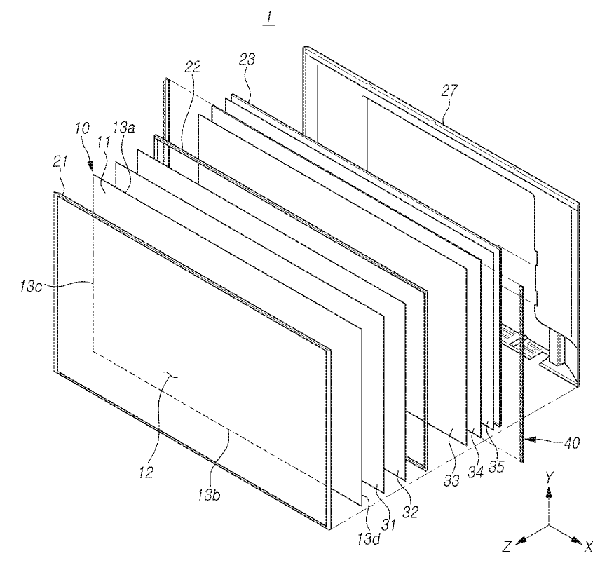

Based on the display device 1 of FIG. 1 and the subsequent figures to be described below, a +X axis and a -X axis may be defined as right and left sides, respectively, with respect to a center of the display device 1. A +Y axis and a -Y axis may be defined as upper and lower sides, respectively, with respect to the center of the display device 1. A +Z axis and a -Z axis may be defined as front and rear sides, respectively, with respect to the center of the display device 1.

According to an embodiment, each component (e.g., a module or a program) of the above-described components may include a single entity or multiple entities. Some of the plurality of entities may be separately disposed in different components.

FIG. 1 is a front exploded perspective view illustrating an example display device 1 according to various embodiments.

Referring to FIG. 1, the display device 1 according to an example embodiment may include various types of devices equipped with a display and capable of playing video content, such as, e.g., and without limitation, a smart TV, a tablet, a monitor, a smartphone, a desktop computer, a laptop computer, or the like.

According to an embodiment, the display device 1 may include a television that processes broadcast images based on broadcast signals, broadcast information, and broadcast data received from transmission equipment of a broadcasting station. However, the display device 1 is not limited to a television, and may include various devices that display information, data, etc. as text, figures, graphs, images, etc., e.g., a computer monitor, a mobile phone, an electronic display board, or signage.

According to an embodiment, the display device 1 may display on a screen a video, a photo, an application, an on-screen display (OSD), a user interface for control, etc. based on signals and data stored in an internal or external storage medium.

According to an embodiment, the display device 1 may be implemented as a smart TV or an internet protocol TV (IP TV). A smart TV may receive and display broadcast signals in real-time, and may have a web browsing function to enable searching and consuming various contents through the internet while displaying real-time broadcast signals.

According to an embodiment, the display device 1 may include a display panel that displays an image. The display panel may be implemented as a liquid crystal panel 10. However, without limitations thereto, the display panel may be a self-luminous organic light emitting diode (OLED) panel or a micro LED panel, in which case a backlight unit to be described below may be omitted.

According to an embodiment, the liquid crystal panel 10 may include a thin film transistor substrate on which thin film transistors are formed in a matrix form, a color filter substrate coupled in parallel with the thin film transistor substrate, and liquid crystal injected between the thin film transistor substrate and the color filter substrate and having optical properties that vary according to changes in voltage or temperature.

According to an embodiment, the liquid crystal panel 10 may have a front surface 11 on which an image is displayed, a rear surface 12 formed on the opposite side of the front surface 11, and four side surfaces 13a, 13b, 13c, 13d on top, bottom, left, and right.

According to an embodiment, the display device 1 may include a backlight unit disposed behind the liquid crystal panel 10 to provide light to the liquid crystal panel 10, and a chassis assembly supporting the backlight unit and the liquid crystal panel 10.

According to an embodiment, the backlight unit may be disposed behind the liquid crystal panel 10 to radiate light toward the liquid crystal panel 10. The backlight unit may include a light source module 40 including a light source and a substrate on which the light source is mounted, and optical members disposed on a movement path of light emitted from the light source.

According to an embodiment, the light source module 40 may be disposed to correspond to at least one side surface of the liquid crystal panel 10. Specifically, the light source module 40 may be disposed to correspond to the left side surface 13c and the right side surface 13d of the liquid crystal panel 10. However, the number and position of the light source modules 40 are not limited thereto. For example, the light source module 40 may be disposed to correspond to the upper side surface 13a and the lower side surface 13b of the liquid crystal panel 10, or disposed to correspond to the four side surfaces 13a, 13b, 13c, 13d, or disposed to correspond to only one of the four side surfaces 13a, 13b, 13c, 13d. For example, the light source module 40 may be disposed behind the liquid crystal panel 10 rather than on the side of the liquid crystal panel 10.

According to an embodiment, a blue LED may be used as the light source. For example, a cold cathode fluorescent lamp (CCFL) or an external electrode fluorescent lamp (EEFL) may be used as the light source.

According to an embodiment, the optical members may be disposed on the movement path of light emitted from the light source module 40 to guide the traveling direction of light or enhance optical characteristics. For example, the optical members may include a light guide plate 34 that guides light emitted from the light source toward the liquid crystal panel 10, a reflective sheet 35 that reflects light emitted from the light source module 40 or light emitted backward from the light guide plate 34, optical sheets 31, 32 that enhance optical characteristics such as brightness enhancement, and a quantum dot sheet 33 that enhances color reproducibility.

According to an embodiment, the optical sheets 31, 32 may be disposed in front of the light guide plate 34 to enhance optical characteristics of light emitted from the light guide plate 34. The optical sheets 31, 32 may include a prism sheet that concentrates light to enhance brightness, a protection sheet that protects other optical sheets from external impacts or foreign objects, a dual brightness enhancement film (DBEF) that enhances brightness by transmitting one polarization and reflecting another polarization, etc.

According to an embodiment, the quantum dot sheet 33 may enhance color reproducibility by changing the wavelength of light. For example, quantum dots, which are semiconductor crystals of a few nanometers in size that emit light, may be dispersedly disposed inside the quantum dot sheet 33. The quantum dots may receive blue light and generate light of various wavelengths according to their size, e.g., light of all colors included in visible light.

According to an embodiment, the chassis assembly may include a rear chassis 23 provided to support the backlight unit, a front chassis 21 provided in front of the rear chassis 23 to support the liquid crystal panel 10, and a middle mold 22 coupled between the front chassis 21 and the rear chassis 23.

According to an embodiment, the rear chassis 23 may be disposed behind the backlight unit. The rear chassis 23 may have a plate shape with an edge portion bent forward. The backlight unit may be received between the rear chassis 23 and the front chassis 21.

According to an embodiment, the rear chassis 23 may dissipate heat generated from heating elements such as the light source to the outside. For example, the rear chassis 23 may be formed of various metal materials such as aluminum or stainless steel (STS), or plastic materials such as ABS.

According to an embodiment, the front chassis 21 may have a frame shape having an opening through which the front surface 11 of the liquid crystal panel 10 is exposed. The middle mold 22 may be coupled between the front chassis 21 and the rear chassis 23 to support the liquid crystal panel 10, the light guide plate 34, and the optical sheets 31, 32.

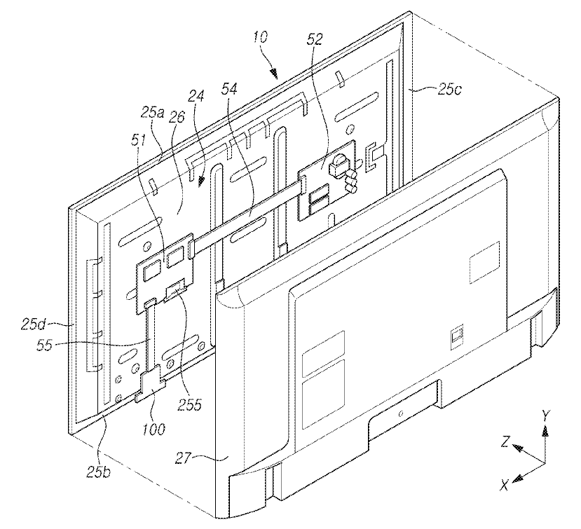

According to an embodiment, on the rear surface (e.g., the rear surface 24 of FIG. 2) of the rear chassis 23, various electronic components for driving display device 1 and processing image signals for displaying images on the display panel and substrates on which they are mounted, and a communication device for communication with external devices may be provided.

According to an embodiment, a cover 27 may be coupled to the rear of the rear chassis 23 to cover the various electrical components and form the rear exterior of the display device 1.

FIG. 2 is a rear exploded perspective view illustrating the example display device 1 according to various embodiments.

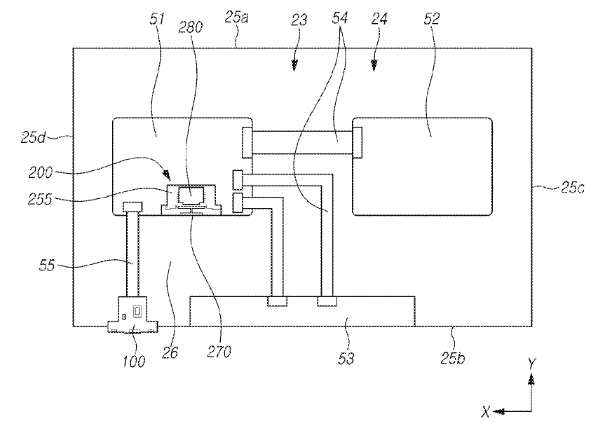

FIG. 3 is a diagram illustrating a rear view of a chassis included in the display device 1 according to various embodiments.

According to an embodiment, a main board 51, a power supply unit (e.g., including a power supply) 52, and a driver unit (e.g., including circuitry) 53 may be connected to each other by a cable 54.

According to an embodiment, electronic components mounted on the main board 51 include a chipset, a memory, etc., and the main board 51 may be provided with line or transmission lines to electrically connect these electronic components. The electronic components provided on the main board 51 may include a tuner for tuning broadcast signals by channel and an image processing unit that processes image signals. The image processing unit including various circuitry may be implemented as individual configurations, e.g., groups of electronic components that may independently perform each process for processing image signals, or may be implemented in the form included in a main system-on-chip (SoC) that integrates various functions. The main SoC may include at least one processor that controls the overall operation of the display device 1 and signal flow between internal components.

According to an embodiment, the processor may include various processing circuitry and load a control program to perform control operations and execute the loaded control program. For example, the processor may include at least one of a central processing unit (CPU), a microprocessor, or an application processor (AP). Thus, the processor may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited /disclosed functions, e.g., in a distributed manner. At least one processor may execute program instructions to achieve or perform various functions.

According to an embodiment, signals generated or combined through the image processing unit may be output to the liquid crystal panel 10 through the driver unit 53. The driver unit 53 may be implemented as a control board provided with a timing controller that controls a driving circuit and enhances image quality.

According to an embodiment, the power supply unit 52 may include a power supply and supply power to each component of the display device 1. The power supply unit 52 converts commercial AC power input from the outside into power supplied to each component of the display device 1 and supplies it, and may include an inverter or a switching mode power supply (SMPS).

According to an embodiment, the main board 51 may be disposed inside from the edges of the display device 1. For example, it may be disposed inside an area 26 from the edges 25a, 25b, 25c, 25d of the rear chassis 23.

According to an embodiment, the display device 1 may include a first communication assembly 100 and a second communication assembly 200. The first communication assembly 100 and the second communication assembly 200 may provide connection between the display device 1 and an external device, and provide a communication function with the external device.

According to an embodiment, the first communication assembly 100 may be electrically connected to the main board 51 by a cable 55.

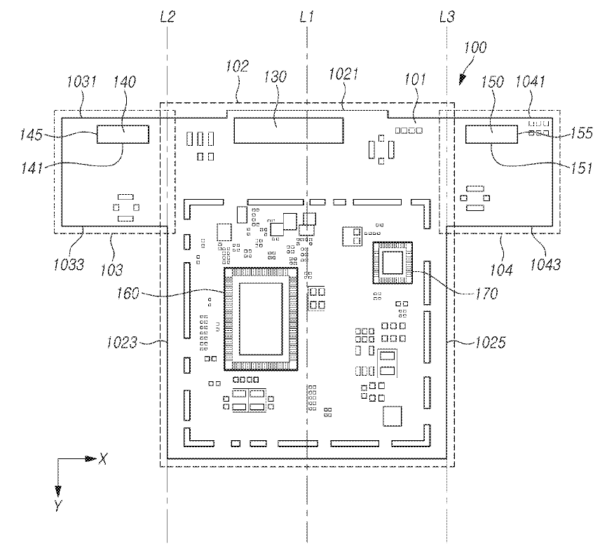

According to an embodiment, a portion of the first communication assembly 100 may be disposed to be exposed outward with respect to a side surface of the display device 1. For example, a portion of the first communication assembly 100 may be disposed to be exposed outward from the lower edge 25b included in the edges 25a, 25b, 25c, 25d of the rear chassis 23. For example, antennas (e.g., the first to third antennas 130, 140, 150 of FIG. 4) included in the first communication assembly 100 may be disposed to be exposed outward from the edge 25b.

According to an embodiment, by disposing a portion of the first communication assembly 100 to be exposed outward with respect to the side surface of the display device 1, the display device 1 may easily establish a wireless connection with an external device.

According to an embodiment, the first communication assembly 100 may include a first communication substrate 101 (see, e.g., FIG. 4), and a first antenna 130, a second antenna 140, and a third antenna 150 disposed on the first communication substrate 101. The first antenna 130 may be referred to as a main antenna. At this time, the second antenna 140 may be referred to as a first antenna in relation to the third antenna 150, and the third antenna 150 may be referred to as a second antenna in relation to the second antenna 140.

According to an embodiment, the first communication substrate 101 may have a "T"-shaped form. The first communication substrate 101 may include a main region 102, and a first region 103 and a second region 104 respectively disposed on two opposite sides of the main region 102.

According to an embodiment, various types of electrical components or electrical circuits for providing wireless communication functions may be disposed on the first communication substrate 101. For example, antennas for radiating electrical signals and integrated circuits (ICs) for providing communication functions may be disposed on the first communication substrate 101.

According to an embodiment, a first antenna 130, a second antenna 140, and a third antenna 150 may be disposed on the first communication substrate 101. For example, the first communication substrate 101 may further include a first communication module 160 including various circuitry for processing RF signals or a power module 170 including various circuitry for controlling power for the components.

According to an embodiment, the first communication module 160 may be implemented according to any one of various communication methods. For example, the first communication module 160 may be configured to perform data communication according to the Wi-Fi standard specification of the institute of electrical and electronics engineers (IEEE).

According to an embodiment, the second antenna 140 and the third antenna 150 disposed on the first communication substrate 101 may transmit/receive electrical signals based on the same communication protocol. For example, the second antenna 140 and the third antenna 150 may transmit/receive signals for performing data communication according to the Wi-Fi standard specification.

According to an embodiment, the first to third antennas 130, 140, 150 may be disposed on the first communication substrate 101 to minimize and/or reduce interference of radiation signals. For example, the second antenna 140 and the third antenna 150 based on the same communication protocol may be disposed on the first communication substrate 101 to secure a predetermined isolation to minimize and/or reduce signal interference. In this regard, the configuration and structure of the first communication assembly 100 are described in greater detail below with reference to FIG. 4.

According to an embodiment, the second communication assembly 200 may include a second communication substrate 255, and a multi-band antenna 270 and a second communication module 280 disposed on the second communication substrate 255.

According to an embodiment, a multi-band antenna 270 that transmits and receives radio frequency (RF) signals for communication between the display device 1 and an external device may be disposed on the second communication substrate 255. For example, the multi-band antenna 270 may transmit/receive RF signals of 2.4 GHz and 5 GHz.

According to an embodiment, a second communication module 280 that processes RF signals may be provided on the second communication substrate 255. The second communication module 280 may be implemented as a chipset-type electronic component mounted on the second communication substrate 255. The second communication module 280 may process RF signals so that the display device 1 may communicate with an external device under the control of the processor.

According to an embodiment, the second communication module 280 may be implemented according to any one of various communication methods. For example, the second communication module 280 may be configured to perform data communication according to the Wi-Fi standard specification of the Institute of Electrical and Electronics Engineers (IEEE).

FIG. 4 is a diagram illustrating a rear view of the first communication assembly 100 viewed from the rear (e.g., +Z-axis direction) with respect to the display device 1 according to various embodiments.

The embodiment of FIG. 4 may be selectively combined with the embodiment of FIGS. 1 to 3.

Referring to FIG. 4, the first communication assembly 100 may include a first communication substrate 101 and one or more electrical components disposed on the first communication substrate 101. For example, the one or more electrical components may include radiators such as antennas (e.g., the first antenna 130, the second antenna 140, the third antenna 150). For example, the one or more electrical components may include an integrated circuit (IC) such as the first communication module 160. For example, the one or more electrical components may include an integrated circuit (IC) such as the power module 170.

According to an embodiment, the first communication substrate 101 may be formed in a "T" shape. For example, the first communication substrate 101 may include a main region 102, a first region 103, and a second region 104. For example, the first region 103 and the second region 104 may be respectively disposed on two opposite sides of the main region 102.

According to an embodiment, the first communication substrate 101 may be provided as a single substrate. For example, the first communication substrate 101 may be integrally formed with a substrate forming the main region 102, a substrate forming the first region 103, and a substrate forming the second region 104. However, without limitations thereto, the first communication substrate 101 may be formed by connecting a plurality of substrates. For example, the first communication substrate 101 may be formed by combining a substrate forming the main region 102, a substrate forming the first region 103, and a substrate forming the second region 104.

According to an embodiment, the size of the main region 102 may be relatively large compared to the size of the first region 103 and/or the size of the second region 104. For example, the area occupied by the main region 102 may be relatively large compared to the area occupied by the first region 103 and/or the area occupied by the second region 104. For example, the size of the first region 103 and the size of the second region 104 may be substantially the same.

According to an embodiment, the first region 103 may be disposed on the left side of the main region 102. The second region 104 may be disposed on the right side of the main region 103. For example, the first region 103 and the second region 104 may be disposed Y-axis symmetrically with respect to the center of the main region 102.

According to an embodiment, a first end 1021 positioned on the upper side (e.g., +Y-axis direction) of the main region 102, a second end 1031 positioned on the upper side (e.g., +Y-axis direction) of the first region 103, and a third end 1041 positioned on the upper side (e.g., +Y-axis direction) of the second region 104 may be substantially aligned. For example, the first end 1021, the second end 1031, and the third end 1041 may be disposed on a straight line.

According to an embodiment, the main region 102 may include a first side surface 1023 and a second side surface 1025. For example, the first side surface 1023 may be connected to a lower end 1033 of the first region 103 and positioned orthogonal to the lower end 1033 of the first region 103. For example, the second side surface 1025 may be positioned orthogonal to a lower end 1043 of the second region 104.

According to an embodiment, the first antenna 130 may be disposed on the main region 102. For example, the first antenna 130 may be implemented as a radiator for radiating an electrical signal (e.g., RF signal) for Bluetooth communication. The first antenna 130 may include a feeding portion for feeding and a grounding portion electrically connected to a ground terminal included in the first communication substrate 101. The first antenna 130 may be configured to radiate electromagnetic waves for Bluetooth communication through the feeding portion and the grounding portion. The feeding refers to a series of processes of supplying an electrical signal from the communication module 160 to an antenna (e.g., the first antenna 130) to convert it into an RF signal during transmission, and converting an RF signal received by the antenna into an electrical signal and transmitting it to the communication module 160 during reception. The feeding portion is electrically connected to the communication module 160 and may receive an electrical signal for controlling the first antenna 130 from the communication module 160.

According to an embodiment, the second antenna 140 may be disposed on the first region 103. The third antenna 150 may be disposed on the second region 104.

According to an embodiment, the second antenna 140 and the third antenna 150 may be implemented as radiators for radiating electrical signals for wi-fi communication.

According to an embodiment, the second antenna 140 may include a second feeding portion 141 electrically connected to the communication module 160 and configured to receive an electrical signal for controlling the second antenna 140, and a second grounding portion 145 electrically connected to a ground terminal included in the first communication substrate 101. The second antenna 140 may radiate an RF signal corresponding to a control signal of the communication module 160 through the second feeding portion 141 and the second grounding portion 145.

According to an embodiment, the second feeding portion 141 may be disposed at the lower portion of the second antenna 140. The second grounding portion 145 may be disposed on the left side of the second antenna 140.

According to an embodiment, the third antenna 150 may include a third feeding portion 151 electrically connected to the communication module 160 and configured to receive an electrical signal for controlling the third antenna 150, and a third grounding portion 155 electrically connected to a ground terminal included in the first communication substrate 101.

The third antenna 150 may radiate an RF signal corresponding to a control signal of the communication module 160 through the third feeding portion 151 and the third grounding portion 155.

According to an embodiment, the third feeding portion 151 may be disposed at the lower portion of the third antenna 150. The third grounding portion 155 may be disposed on the right side of the third antenna 150.

According to an embodiment, the second antenna 140 and the third antenna 150 may be disposed symmetrically with respect to the center of the first communication assembly 100. For example, the second antenna 140 and the third antenna 150 may be disposed symmetrically with respect to a first reference line L1 passing through the center of the main region 102.

According to an embodiment, the second feeding portion 141 included in the second antenna 140 and the third feeding portion 151 included in the third antenna 150 may be disposed symmetrically with respect to the first reference line L1.

According to an embodiment, the second grounding portion 145 included in the second antenna 140 and the third grounding portion 155 included in the third antenna 150 may be disposed symmetrically with respect to the first reference line L1.

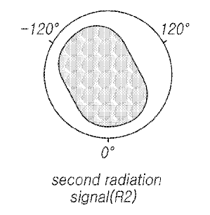

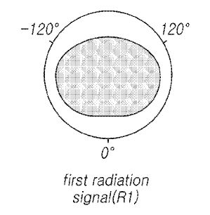

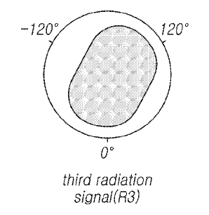

According to an embodiment, by disposing the second antenna 140 and the third antenna 150 symmetrically with respect to the first reference line L1, an electrical signal radiated from the second antenna 140 (e.g., the second electrical signal R2 of FIG. 6A) and an electrical signal radiated from the third antenna 150 (e.g., the third electrical signal R3 of FIG. 6C) may be orthogonal to each other. This is described in greater detail below with reference to FIG. 6.

According to an embodiment, by the arrangement structure of the second antenna 140 and the third antenna 150, the first communication assembly 100 may secure a predetermined isolation to reduce deterioration of radiation performance between the antennas 130, 140, 150. The first communication assembly 100 may enhance wireless connectivity between the display device 1 and an external device by minimizing and /or reducing interference between radiated signals.

According to an embodiment, for electrical signals radiated from the second antenna 140 and the third antenna 150 to be orthogonal to each other, the second grounding portion 145 included in the second antenna 140 and the third grounding portion 155 included in the third antenna 150 may be positioned in a predetermined region.

According to an embodiment, the second grounding portion 145 included in the second antenna 140 may be positioned to the left of a second auxiliary line L2 defined as a straight line where the main region 102 and the first region 103 meet. For example, the second grounding portion 145 may be positioned outside the main region 102 with respect to the second auxiliary line L2.

According to an embodiment, the third grounding portion 155 included in the third antenna 150 may be positioned to the right of a third auxiliary line L3 defined as a straight line where the main region 102 and the second region 104 meet. For example, the third grounding portion 155 may be positioned outside the main region 102 with respect to the third auxiliary line L3.

According to an embodiment, by positioning the second grounding portion 145 and the third grounding portion 155 outside the main region 102 with respect to the second auxiliary line L2 and the third auxiliary line L3, respectively, a signal R2 radiated from the second antenna 140 and a signal R3 radiated from the third antenna 150 may be orthogonal to each other. For example, in case that the second grounding portion 145 and the third grounding portion 155 are positioned inside the main region 102 with respect to the second auxiliary line L2 and the third auxiliary line L3, respectively, the signal R2 radiated from the second antenna 140 and the signal R3 radiated from the third antenna 150 may be radiated along the edge of the main region 102, and antenna performance may deteriorate due to signal interference.

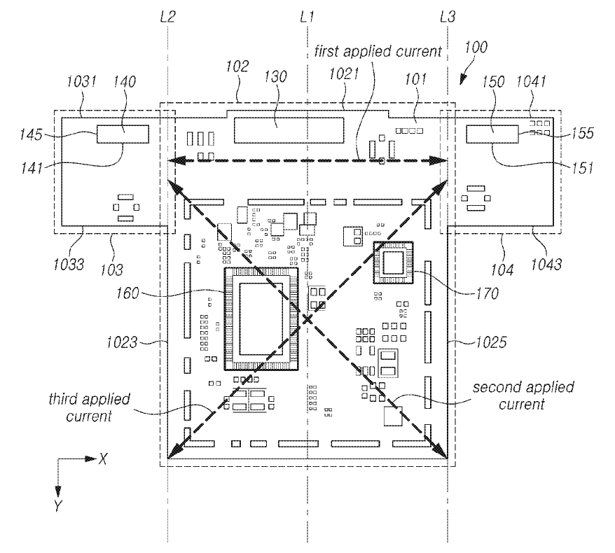

FIG. 5 is a diagram illustrating the directions of current applied to the first to third antennas 130, 140, 150 (e.g., the first antenna 130, the second antenna 140, and the third antenna 150 of FIG. 4) included in the first communication assembly 100 (e.g., the first communication assembly 100 of FIG. 3) according to various embodiments.

The embodiment of FIG. 5 may be selectively combined with the embodiment of FIG. 4.

Referring to FIG. 5, each of the first antenna 130, the second antenna 140, and the third antenna 150 may be configured to radiate an electrical signal of a specific frequency band to perform predetermined communication. For example, electromagnetic waves of a specific frequency band may be radiated from feeding portions (e.g., the second feeding portion 141, the third feeding portion 151 of FIG. 4) included in the first to third antennas 130, 140, 150. The first to third antennas 130, 140, 150 may be configured to radiate electromagnetic waves of a specific frequency band by current applied from a feeding unit or a power supply unit (e.g., the power supply unit 52 of FIG. 2) to the first communication assembly 100.

According to an embodiment, an electrical signal radiated from the first antenna 130 is defined as a "first radiation signal R1 (see, e.g., FIG. 6A)". For example, an electrical signal radiated from the second antenna 140 is defined as a "second radiation signal R2 (see, e.g., FIG. 6B)". An electrical signal radiated from the third antenna 150 is defined as a "third radiation signal R3 (see, e.g., FIG. 6C)".

According to an embodiment, a predetermined current may be applied to the first antenna 130 for an electrical signal to be radiated from the first antenna 130, and the current may be referred to as a first applied current. A predetermined current may be applied to the second antenna 140 for an electrical signal to be radiated from the second antenna 140, and the current may be referred to as a second applied current. A predetermined current may be applied to the third antenna 150 for an electrical signal to be radiated from the third antenna 150, and the current may be referred to as a third applied current.

According to an embodiment, the direction and intensity of the radiation signal of each of the first radiation signal R1, the second radiation signal R2, and the third radiation signal R3 may be determined by the shape of the first communication substrate 101 and the arrangement structure of the first to third antennas 130, 140, 150.

According to an embodiment, the first radiation signal R1 may be radiated from the first antenna 130 and generally radiated in the left-right direction (e.g., X-axis direction). For example, a portion of the first radiation signal R1 may be radiated toward the first region 103 (e.g., the first region 103 of FIG. 4), and a portion may be radiated toward the second region 104 (e.g., the second region 104 of FIG. 4).

According to an embodiment, the second radiation signal R2 may be radiated from the second antenna 140 and radiated obliquely in a diagonal downward direction. For example, the second radiation signal R2 may be radiated from the second feeding portion (e.g., the second feeding portion 141 of FIG. 4) toward the lower right of the main region 102 (e.g., the main region 102 of FIG. 4).

According to an embodiment, as the second grounding portion 145 (e.g., the second grounding portion 145 of FIG. 4) included in the second antenna 140 is disposed outside the main region 102 with respect to the second auxiliary line L2 (e.g., the second auxiliary line L2 of FIG. 4), and the shape of the first communication substrate 101 is formed in a "T" shape, the second radiation signal R2 may be radiated toward the lower right of the main region 102.

According to an embodiment, the third radiation signal R3 may be radiated from the third antenna 150 and radiated obliquely in a diagonal downward direction. For example, the third radiation signal R3 may be radiated from the third feeding portion 151 (e.g., the third feeding portion 151 of FIG. 4) toward the lower left of the main region 102.

According to an embodiment, as the third grounding portion 155 (e.g., the third grounding portion 155 of FIG. 4) included in the third antenna 150 is disposed outside the main region 102 with respect to the third auxiliary line L3 (e.g., the third auxiliary line L3 of FIG. 4), and the shape of the first communication substrate 101 is formed in a "T" shape, the third radiation signal R3 may be radiated toward the lower left of the main region 102.

According to an embodiment, the second radiation signal R2 and the third radiation signal R3 may be radiated orthogonally to each other. For example, the angle formed by the second radiation signal R2 and the third radiation signal R3 may be about 90 degrees.

According to an embodiment, by the second radiation signal R2 and the third radiation signal R3 being orthogonal to each other, isolation between the second antenna 140 and the third antenna 150 may be secured above a critical level. As a result, interference between the second radiation signal R2 and the third radiation signal R3 radiated from the second antenna 140 and the third antenna 150, respectively, may be decreased, and the antenna performance of the first communication assembly 100 may be enhanced.

According to an embodiment, through the shape of the first communication substrate 101 and the arrangement design between the second antenna 140 and the third antenna 150, isolation between antennas may be secured without a separate component (e.g., metal structure), and the performance of the communication assembly 100 may be enhanced.

FIGS. 6A, 6B and 6C are diagrams illustrating radiation patterns of electrical signals radiated from the first to third antennas (e.g., the first antenna 130, the second antenna 140, and the third antenna 150 of FIG. 4) included in the first communication assembly (e.g., the first communication assembly 100 of FIG. 3) according to various embodiments.

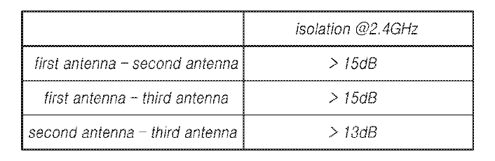

FIG. 7 is a table showing mutual isolation between the first to third antennas 130, 140, 150 included in the first communication assembly 100 according to various embodiments.

FIG. 6 illustrates radiation patterns in case that the first to third antennas 130, 140, 150 radiate electromagnetic waves corresponding to a frequency band of 2.4 GHz, and FIG. 7 is a table showing isolation between two antennas among the first to third antennas 130, 140, 150 in case that the first to third antennas 130, 140, 150 radiate electromagnetic waves corresponding to a frequency band of 2.4 GHz.

The embodiments of FIGS. 6 and 7 may be selectively combined with the embodiments of FIGS. 1 to 5.

FIG. 6A illustrates a radiation pattern of a signal radiated from the second antenna 140 (e.g., the second radiation signal R2), FIG. 6B illustrates a radiation pattern of a signal radiated from the first antenna 130 (e.g., the first radiation signal R1), and FIG. 6C illustrates a radiation pattern of a signal radiated from the third antenna 150 (e.g., the third radiation signal R3).

For example, the radiation patterns illustrated in FIGS. 6A, 6B and 6C are radiation patterns that reflect all electromagnetic waves formed at the feeding portions (e.g., the second feeding portion 141, the third feeding portion 151 of FIG. 5) and grounding portions (e.g., the second grounding portion 145, the third grounding portion 155 of FIG. 5) of each antenna 130, 140, 150 by currents (e.g., the first applied current, the second applied current, the third applied current of FIG. 5) applied from the circuit board (e.g., the first communication substrate 101 of FIG. 5) to each antenna (e.g., the first antenna 130, the second antenna 140, the third antenna 150). for example, each radiation pattern R2, R3 illustrated in FIGS. 6A and 6C illustrates a radiation pattern symmetric with respect to the first antenna 130 as currents applied from the first communication substrate 101 to each of the second antenna 140 and the third antenna 150 are orthogonal to each other.

According to an embodiment, in FIG. 6B, the first radiation signal R1 may be generally radiated toward the left and right sides (e.g., +X axis or -X-axis direction of FIG. 4) with respect to the first antenna 130. For example, the first radiation signal R1 may be radiated in about +90 degrees or -90 degrees direction from the center of the first antenna 130.

According to an embodiment, in FIG. 6A, the second radiation signal R2 may be generally radiated toward the lower right (or upper left) of the main region (e.g., the main region 102 of FIG. 4) with respect to the second antenna 140. For example, the second radiation signal R2 may be radiated in about +60 degrees or -120 degrees direction from the center of the second antenna 140.

According to an embodiment, in FIG. 6B, the third radiation signal R3 may be generally radiated toward the lower left (or upper right) of the main region 102 with respect to the third antenna 150. For example, the third radiation signal R3 may be radiated in about +120 degrees or -60 degrees direction from the center of the third antenna 150.

According to an embodiment, the second radiation signal R2 and the third radiation signal R3 may be radiated orthogonally to each other. As a result, a predetermined isolation is secured between the second antenna 140 and the third antenna 150, and signal interference between the second radiation signal R2 radiated from the second antenna 140 and the third radiation signal R3 radiated from the third antenna 150 may be decreased. The antenna performance of the first communication assembly 100 may be enhanced.

Referring to FIG. 7, the table shows isolation between antennas according to the arrangement structure between the first communication substrate (e.g., the first communication substrate 101 of FIG. 4) included in the first communication assembly 100 and the first to third antennas 130, 140, 150 disposed on the first communication substrate 101. For example, the values listed in the shown table indicate isolation between two different antennas among the first to third antennas 130, 140, 150.

According to an embodiment, the isolation between the first antenna 130 and the second antenna 140 may be set to 15 dB or more.

According to an embodiment, the isolation between the first antenna 130 and the third antenna 150 may be set to 15 dB or more.

According to an embodiment, the isolation between the second antenna 140 and the third antenna 150 may be set to 13 dB or more.

According to an embodiment, the first communication substrate 101 is formed in a "T" shape, and the first to third antennas 130, 140, 150 are respectively disposed in the main region 102, the first region (e.g., the first region 103 of FIG. 4), and the second region (e.g., the second region 104 of FIG. 4) of the first communication substrate 101, so that the first to third antennas 130, 140, 150 may secure isolation above a critical level and reduce deterioration of radiation performance between adjacent antennas. As a result, while securing a minimum separation distance between the first to third antennas 130, 140, 150 included in the first communication assembly 100, isolation between antennas may be ensured, and antenna performance may be enhanced without installing a separate structure.

According to an embodiment, the first communication assembly 100 implements miniaturization of the first communication assembly 100 based on the "T"-shaped form of the first communication substrate 101 and the arrangement of the first to third antennas 130, 140, 150, and enhances antenna performance, so that the display device (e.g., the display device 1 of FIG. 1) of the disclosure may enhance connectivity with an external device. As a result, the display device 1 may smoothly transmit/receive data with an external device, and the quality of audio output from the display device 1 or a screen displayed on the display device 1 may be enhanced.

The display device 1 according to an example embodiment of the disclosure may provide a communication assembly (e.g., the first communication assembly 100 of FIG. 3) with enhanced antenna performance to enhance connectivity with an external device.

The display device 1 according to an embodiment of the disclosure may provide the communication assembly 100 with enhanced antenna performance while being implemented in reduced weight and size.

The display device 1 according to an embodiment of the disclosure may provide the communication assembly 100 that secures isolation between antennas (e.g., the first antenna 130, the second antenna 140, and the third antenna 150 of FIG. 4) and reduces interference between radiation signals.

The display device 1 according to an embodiment of the disclosure may provide the communication assembly 100 with enhanced antenna performance through the shape of a substrate (e.g., the first communication substrate 101 of FIG. 4) and the arrangement structure of antennas disposed on the substrate, without including a separate metal structure to secure isolation.

Effects obtainable from the disclosure are not limited to the above-mentioned effects, and other effects not mentioned may be apparent to one of ordinary skill in the art from the description.

A display device 1 according to an example embodiment of the disclosure may include a display panel 10 and a communication assembly 100. The communication assembly 100 may include a T-shaped communication substrate 101 including a main region 102, and a first region 103 and a second region 104 respectively disposed on two opposite sides of the main region 102, a first antenna 140 disposed on a surface of the first region 103, and a second antenna 150 disposed on a same plane as the first region 103 and disposed on a surface of the second region 104.

According to an embodiment, the first antenna 140 and the second antenna may be disposed symmetrically with respect to a center of the main region 102.

According to an embodiment, the first antenna 140 may include a first feeding portion 141 and a first grounding portion 145. The second antenna 150 may include a second feeding portion 151 and a second grounding portion 155.

According to an embodiment, a first radiation signal radiated from the first antenna 141 and a second radiation signal radiated from the second antenna 150 may be orthogonal to each other.

According to an embodiment, a first direction in which the first grounding portion 145 faces and a second direction in which the second grounding portion 155 faces may be 180 degrees.

According to an embodiment, a first frequency band of the first antenna 140 may be the same as or different from a second frequency band of the second antenna.

According to an embodiment, the first frequency band may be 2.4GHz or 5.0GHz.

According to an embodiment, the second frequency band may be 2.4GHz or 5.0GHz.

According to an embodiment, the main region 102 may have a first side surface 1023 connected to one end of the first region 103 and orthogonal to the one end, and a second side surface 1025 connected to one end of the second region 104 and orthogonal to the one end. One end of the first grounding portion 145 may be positioned to an outside of the first side surface 1023 with respect to a center of the main region 102. One end of the second grounding portion 155 may be positioned to an outside of the second side surface 1025 with respect to the center of the main region 102.

According to an embodiment, an upper end 1021 of the main region 102, an upper end 1031 of the first region 103, and an upper end 1041 of the second region 104 may be aligned.

According to an embodiment, the communication assembly 100 may be disposed on a rear surface of the display panel 10.

According to an embodiment, a partial region of the communication assembly 100 may be disposed to be exposed outward with respect to an adjacent side surface of the display panel 10.

According to an embodiment, the partial region may include an upper end 1021 of the main region 102, an upper end 1031 of the first region 103, and an upper end 1041 of the second region 104 which are aligned.

A communication assembly 100 according to an example embodiment of the disclosure may include a T-shaped communication substrate 101 including a main region 102, and a first region 103 and a second region 104 respectively disposed on two opposite sides of the main region 102, a first antenna 140 disposed on a surface of the first region 103, and a second antenna 150 disposed on a same plane as the first region 103 and disposed on a surface of the second region 104. A size of the first region 103 and a size of the second region 104 may be smaller than a size of the main region 102. A upper end 1021 of the main region 102, an upper end 1031 of the first region 103, and an upper end 1041 of the second region 104 may be aligned.

According to an embodiment, the first antenna 140 and the second antenna may be disposed symmetrically with respect to a center of the main region 102.

According to an embodiment, the first antenna 140 may include a first feeding portion 141 and a first grounding portion 145. The second antenna 150 may include a second feeding portion 151 and a second grounding portion 155.

According to an embodiment, a first radiation signal radiated from the first antenna 140 and a second radiation signal radiated from the second antenna 150 may be orthogonal to each other.

According to an embodiment, a first direction in which the first grounding portion 145 faces and a second direction in which the second grounding portion 155 faces may be 180 degrees.

According to an embodiment, a first frequency band of the first antenna 140 may be the same as or different from a second frequency band of the second antenna.

According to an embodiment, the main region 102 may have a first side surface 1023 connected to one end of the first region 103 and orthogonal to the one end, and a second side surface 1025 connected to one end of the second region 104 and orthogonal to the one end. One end of the first grounding portion 145 may be positioned to an outside of the first side surface 1023 with respect to a center of the main region 102. One end of the second grounding portion 155 may be positioned to an outside of the second side surface 1025 with respect to the center of the main region 102.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. A display device, comprising:
a display panel; and
a communication assembly,
wherein the communication assembly includes:
a T-shaped communication substrate including a main region, and a first region and a second region respectively disposed on two opposite sides of the main region;
a first antenna disposed on a surface of the first region; and
a second antenna disposed on a same plane as the first region and disposed on a surface of the second region.

2. The display device of claim 1, wherein the first antenna and the second antenna are disposed symmetrically with respect to a center of the main region.

3. The display device of claim 1, wherein the first antenna includes a first feeding portion and a first grounding portion, and
wherein the second antenna includes a second feeding portion and a second grounding portion.

4. The display device of claim 3, wherein the first antenna is configured to radiate a first radiation signal and the second antenna is configured to radiate a second radiation signal, the first and second radiation signals being orthogonal to each other.

5. The display device of claim 1, wherein a first direction in which the first grounding portion faces and a second direction in which the second grounding portion faces are 180 degrees with respect to each other.

6. The display device of claim 1, wherein a first frequency band of the first antenna is the same as or different from a second frequency band of the second antenna.

7. The display device of claim 6, wherein the first frequency band is 2.4GHz or 5.0GHz.

8. The display device of claim 6, wherein the second frequency band is 2.4GHz or 5.0GHz.

9. The display device of claim 3, wherein the main region has a first side surface connected to one end of the first region and orthogonal to the one end, and a second side surface connected to one end of the second region and orthogonal to the one end,
wherein one end of the first grounding portion is positioned to an outside of the first side surface with respect to a center of the main region, and
wherein one end of the second grounding portion is positioned to an outside of the second side surface with respect to the center of the main region.

10. The display device of claim 1, wherein an upper end of the main region, an upper end of the first region, and an upper end of the second region are aligned.

11. The display device of claim 1, wherein the communication assembly is disposed on a rear surface of the display panel.

12. The display device of claim 1, wherein a partial region of the communication assembly is disposed to be exposed outward with respect to an adjacent side surface of the display panel.

13. The display device of claim 12, wherein the partial region includes an upper end of the main region, an upper end of the first region, and an upper end of the second region which are aligned.

14. A communication assembly, comprising:
a T-shaped communication substrate including a main region, and a first region and a second region respectively disposed on two opposite sides of the main region;
a first antenna disposed on a surface of the first region; and
a second antenna disposed on a same plane as the first region and disposed on a surface of the second region,
wherein a size of the first region and a size of the second region are each smaller than a size of the main region, and
wherein an upper end of the main region, an upper end of the first region, and an upper end of the second region are aligned.

15. The communication assembly of claim 14, wherein the first antenna and the second antenna are disposed symmetrically with respect to a center of the main region.

16. The communication assembly of claim 14, wherein the first antenna includes a first feeding portion and a first grounding portion, and
wherein the second antenna includes a second feeding portion and a second grounding portion.

17. The communication assembly of claim 16, wherein the first antenna is configured to radiate a first radiation signal, and the second antenna is configured to radiate a second radiation signal, wherein the first and second radiation signals are orthogonal to each other.

18. The communication assembly of claim 14, wherein a first direction in which the first grounding portion faces and a second direction in which the second grounding portion faces are 180 degrees with respect to each other.

19. The communication assembly claim 14, wherein a first frequency band of the first antenna is the same as or different from a second frequency band of the second antenna.

20. The communication assembly of claim 16, wherein the main region has a first side surface connected to one end of the first region and orthogonal to the one end, and a second side surface connected to one end of the second region and orthogonal to the one end,
wherein one end of the first grounding portion is positioned to an outside of the first side surface with respect to a center of the main region, and
wherein one end of the second grounding portion is positioned to an outside of the second side surface with respect to the center of the main region.
